(19) United States
(12) Patent Application Publication
(10) Pub. No.: US 2007/0094253 A1
(43) Pub. Date: Apr. 26, 2007

(54) System for Providing Context Associated with Data mining Results

(76) Inventor: Graham Anthony Bent, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/550,914

(22) Filed: Oct. 19, 2006

(30) Foreign Application Priority Data
Oct. 22, 2005 (GB) 0521556.1

(51) Int. Cl. G06F 17/30

(52) U.S. Cl. 707/5

(57) ABSTRACT

A system for providing context associated with data mining results, for use with a data mining application for mining a first document set and for determining, in response to the mining, a correlation. The system comprises: a search means for comparing the correlation against content of a second document set to search for a matching correlation; and an extractor for extracting, in response to finding the matching correlation in a document of the second document set, a set of contextual data associated with the document of the second document set.

### FIELD OF THE INVENTION

The present invention relates to a system for providing context associated with data mining results.

### BACKGROUND OF THE INVENTION

“Data mining is described as the process of discovering previously unknown, comprehensible and actionable information from large databases of structured data” (Simoudis, E. (1995) “Reality check for data mining”, IBM Almaden Research Centre) Therefore, in principle, data mining provides answers without a user having to ask specific questions.

Typically, the stated objective of providing comprehensible and actionable information is not met. While data mining is able to discover relationships within the data (e.g. correlations), it offers no explanation as to the possible cause of the relationship. The reason for a particular relationship discovered by data mining may be well known to a domain expert but not to the user undertaking the data mining. Thus, there is a need to provide comprehensible information in response to a data mining process.

### DISCLOSURE OF THE INVENTION

According to a first aspect there is provided a system for providing context associated with data mining results, for use with a data mining application for mining a first document set and for determining, in response to the mining, a correlation, wherein the system comprises: a search means for comparing the correlation against content of a second document set to search for a matching correlation; and an extractor for extracting, in response to finding the matching correlation in a document of the second document set, a set of contextual data associated with the document of the second document set.

Preferably, the system further comprises a generator for using the correlation to generate a search input. More preferably, the search means compares the search input to the content of the second document set. Still more preferably, the search means generates search results comprising components of the matching correlation.

In a preferred embodiment, the system further comprises an analyser for analysing the search results to generate data associated with the matching correlation. Preferably, the analyser executes a proximity analysis. More preferably, the system further comprises a display component for displaying the set of contextual data associated with the document. Still more preferably, the set of contextual data associated with the document is associated with the correlation. In a preferred embodiment, a size of the set of contextual data associated with the document is pre-configurable. Preferably, a location of the set of contextual data associated with the document is pre-configurable.

Preferably, the system further comprises a ranker for ranking, in response to finding the matching correlation in a plurality of documents of the second document set, the plurality of documents. More preferably, the system further comprises a selector for selecting at least one of the ranked plurality of documents. Still more preferably, the extractor extracts a set of contextual data associated with the selected document.

Preferably, the system further comprises a ranker for ranking, in response to extraction of a plurality of sets of data, the plurality of sets of contextual data. More preferably, the system further comprises a selector for selecting at least one of the ranked plurality of sets of contextual data. Still more preferably, a display component displays the selected set of contextual data.

According to a second aspect there is provided a method for providing a service to a customer for providing context associated with data mining results, for use with a data mining application for mining a first document set and for determining, in response to the mining, a correlation, comprising: comparing the correlation against a second document set to search for the correlation; and extracting, in response to finding the correlation in a document of the second document set, a set of contextual data associated with the document.

According to a third aspect there is provided a method for providing context associated with data mining results, for use with a data mining application for mining a first document set and for determining, in response to the mining, a correlation wherein the method comprises the steps of: comparing the correlation against content of a second document set to search for a matching correlation; and extracting, in response to finding the matching correlation in a document of the second document set, a set of contextual data associated with the document of the second document set.

According to a fourth aspect there is provided a computer program comprising program code means adapted to perform all the steps of the methods described above when said program is run on a computer.

### BRIEF DESCRIPTION OF THE DRAWINGS

The present invention will now be described, by way of example only, with reference to preferred embodiments thereof, as illustrated in the following drawings:

FIG. 1 is a block diagram of a system in which the preferred embodiment is implemented; and

FIG. 2 is a flow chart showing the operational steps involved in a preferred embodiment.

### DETAILED DESCRIPTION OF THE PREFERRED EMBODIMENTS

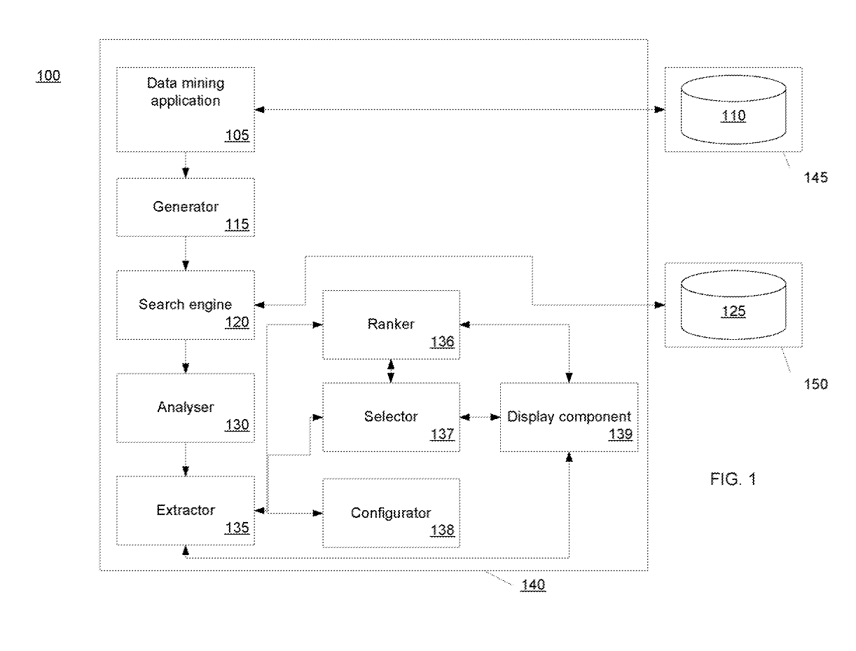

The preferred embodiment will now be described with reference to the FIGs. FIG. 1 is a block diagram of a system (100) in which the preferred embodiment may be implemented, wherein there is shown a data processing system (140) comprising a number of components. One such component is a data mining application (105) for mining a set of records (110).

Preferably, the set of records comprises data (e.g. data collected from trials such as data associated with customers, data associated with patients etc.) from which correlations are determined.

In the preferred embodiment, the records (110) reside on a first remote data processing system (145). Alteratively, the records (110) can reside on the data processing system (140).

The data mining application (105) communicates with a generator (115) for generating a search input. The generator (115) communicates the search input to a search engine (120), which uses the search input to search a document corpus (125).

In one example, the document corpus (125) comprises a set of documents comprising a plurality of topics e.g. documents from the Internet. In another example, the document corpus (125) comprises a set of documents associated with the set of records e.g. marketing data (that is therefore associated with customer data), medical data (that is therefore associated with patient data etc.) etc.

Preferably, the document corpus (125) is indexed (e.g. by a search engine) to enable a search to be carried out more efficiently. For example, words are ordered alphabetically in the index, stop words (such as “the”, “and” etc.) are removed etc.

In the preferred embodiment, the document corpus (125) resides on a second remote data processing system (150). Alternatively, the document corpus (125) can reside on the data processing system (140).

The search engine (120) provides results from the search to an analyser (130), which analyses the results. An extractor (135) extracts an output associated with the results and the output can be displayed (e.g. on a display screen).

It will be understood by one of ordinary skill in the art that each component can reside on any data processing system.

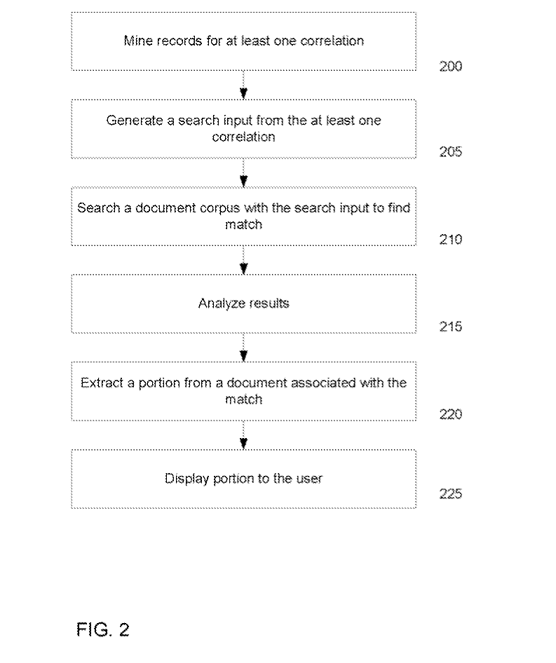

A process according to the preferred embodiment will now be described with reference to FIG. 1 and FIG. 2. The data mining application (105) mines (step 200) the set of records (110). In a first example described herein, the data mining application (105) discovers a correlation in the set of records (110) and expresses the correlation as an association rule.

An association rule takes the form:

Left-hand side implies right-hand side.

Traditionally, the technique has been used to perform market basket analysis. In the context of market basket analysis an example association rule may have the following form:

If product A is purchased, then this implies product B will also be purchased at the same time.

In the language of association rules, the left-hand side is called the rule “Body” and the right-hand side, the rule “Head”. In general, the rule Body can contain multiple items, but the rule Head only has one item. For example:

If product A and B and C are purchased, then this implies that product D will also be purchased.

In addition to the rule, the data mining application (105) can calculate one or more statistics about the rule. The statistics allow the correlations found by rules to be ordered. For example, the following statistical measures can be used to define the rule: “confidence” in the association; “support for the association”; “lift” value for the association and “type” of the association. Preferably, one or more of these statistical measures can be used to rank and select a rule (i.e. in accordance with the rule's degree of statistical significance).

In the first example, the association rule is shown below,

<High blood pressure> AND <High cholesterol>=>Heart attack

The data mining application (105) transmits the rule to the generator (115). The generator (115) utilises the rule to generate (step 205) a search input.

In one example, the generator (115) sends the rule, unchanged, to the search engine (120), wherein the rule can be used as a search input by the search engine directly.

In another example, the generator (115) parses the rule and converts at least one component of the rule to generate a search input that can be used by a search engine (i.e. wherein the search engine cannot use the rule as a search input directly without conversion having taken place first). That is, the generator (115) expresses a component of the rule in a first format as a second format associated with the search engine.

In a conversion example, the generator (115) expresses a component of a rule comprising a post code (e.g. S1RG 234) representing a geographic location as the geographic location it represents (e.g. Southampton), by matching the component to a store of geographic locations.

In another conversion example, the generator (115) removes a portion of the component that is specific to a format associated with the set of records (110) from which the rule (and thus, the component) is derived. For example, for a component, namely, “<High blood pressure>”, brackets (“<>”) are removed resulting in a second format, namely “High blood pressure”.

In yet another conversion example, the generator (115) splits a component into further sub-components e.g. a component “Blood Pressure >25.2” is split into two sub-components “Blood Pressure” and “>25.2”.

In yet another conversion example, the generator (115) converts a numeric component to a range of numerals. For example “<10” is converted to any value that is less than 10 (e.g. 0, 1, 2 . . . 9).

In the first example, the search input is shown below, wherein the generator (115) removes brackets and conditions (i.e. “AND” and “=>”):

“High blood pressure” “High cholesterol” “Heart attack”

In response to generating a search input, the generator (115) sends the search input to the search engine (120). The search engine (120) utilises the search input to search (step 210) the document corpus (125) for any “matching” components. The scope of the term match herein comprises an exact match, a substantial match (e.g. a substantial textual match; a substantial numeric match e.g. if a numeric component in a rule is “<10”, a substantially matching numeric component is “9”) etc.

If a matching component is found, the document comprising the matching component is termed herein as “a candidate document”.

In response to finding a plurality of matching components (e.g. within one or more candidate documents), preferably, the search engine (120) applies at least one technique to the matching components to organise data associated with the matching components (e.g. taxonomy, ontology), to retrieve further data associated with the matching components (e.g. fuzzy searching) etc. It should be understood, that in response to applying a technique, the search engine (120) can filter out candidate documents, such that the filtered out candidate documents are not sent to the analyser (130). For example, a candidate document comprising no further data as a result of the search engine (120) conducting a fuzzy search can be filtered out.

In the first example, the search engine (120) finds the following matching components in first, second and third candidate documents:

“High blood pressure” “High cholesterol” “Heart attack”

The search engine (120) passes the first, second and third candidate documents and associated data (e.g. location data associated with a location of each matching component in a candidate document, length data associated with a matching component etc.) to the analyser (130).

| Component | Document id | Location | Length |
|---|---|---|---|
| High blood pressure | 1 | 13 | 19 |
| | 2 | 12 | 19 |
| | 3 | 50 | 19 |
| High cholesterol | 1 | 611 | 16 |
| | 2 | 01 | 16 |
| | 3 | 65 | 16 |
| Heart attack | 1 | 248 | 12 |
| | 2 | 21 | 12 |
| | 3 | 75 | 12 |

In one embodiment the search engine (120) passes all candidate documents found and associated data to the analyser (130). Alternatively, in response to applying at least one technique, the search engine (120) passes candidate documents (and associated data) that have not been filtered out to the analyser (130).

In response to receiving the first candidate document, preferably, the analyser (130) performs analysis (step 215) on a candidate document to generate further data associated with the matching components.

In a first analysis example, the analyser (130) performs a proximity analysis on the matching components by comparing the locations of matching components in a document against a proximity threshold.

In one example, the proximity threshold is set as “within a document”. The analyser (130) analyses the location of matching components in the first, second and third candidate documents. The analyser (130) determines that the matching components in each document meet the proximity threshold. That is, the searched components are all located in the same document, in this case they are located in all of the three documents. In another example, the proximity threshold is set as “the first fifty locations” in a document. The analyser (130) analyses the location of matching components in the first, second and third candidate documents. The analyser (130) determines that the matching components in the first document do not match the proximity threshold because the matching components are located at locations 13, 611 and 248; that the matching components in the second document match the proximity threshold because the matching components are located at locations 12, 01 and 21; and that the matching components in the third document do not match the proximity threshold because the matching components are located at locations 50 01 and 75.

In a second analysis example, the analyser (130) performs a pattern match on the matching components by comparing the matching components against a pre-configured pattern (e.g. pre-configured by an administrator, a system etc.). In one example, the pattern is a particular grammatical structure.

In another example, the pattern is a sequential structure assigned to matching components e.g. the sequential structure specifies that the matching components occur in the sequence: “High cholesterol, High blood pressure, Heart attack”. The analyser (130) analyses the location of matching components in the first, second and third candidate documents. The analyser (130) determines that the matching components in the first document do not match the sequential structure because the matching components occur in the sequence “High blood pressure, Heart attack, High cholesterol,”, that the matching components in the second document do match the sequential structure because the matching components occur in the sequence “High cholesterol, High blood pressure, Heart attack”; and that the matching components in the third document do not match the sequential structure because the matching components occur in the sequence “High blood pressure, High cholesterol, Heart attack”.

It should be understood that in response to the analysis carried out by the analyser (130), the analyser (130) can fitter out a candidate document. Preferably, a candidate document that is filtered out by the analyser (130) is not sent to the extractor (135). Alternatively, the analyser (130) sends all candidate documents except for candidate documents filtered out by the search engine (120) to the extractor (135). Alternatively, the analyser (130) sends all candidate documents (i.e. wherein candidate documents have not been filtered out by the search engine (120) or the analyser (130)) to the extractor (135).

Using the analysis examples above, in the first example, the analyser (130) filters out a candidate document if it does not meet the proximity threshold of “the first fifty locations”. Thus, the first candidate document and the third candidate document are filtered out and the second candidate document is not filtered out. Using the analysis examples above, in the first example, the analyser (130) further filters out a candidate document if it does not meet a sequential structure, namely, “High cholesterol, High blood pressure, Heart attack”. Thus, since the second candidate document does match the sequential structure, it is not filtered out by the analyser (130).

Thus, the analyser (130) sends the second candidate document to the extractor (135). Preferably, the analyser (130) also sends associated data (e.g. location data associated with a location of each matching component in a candidate document, length data associated with a matching component) and the results of its analysis (e.g. analysis of proximity, analysis of a sequential structure etc.) to the extractor (135).

The extractor (135) extracts (step 220) a portion associated with a candidate document (i.e. an output). A size of the portion can be pre-configured by a configurator (138), for example, in terms of a pre-configured amount of data associated with a portion (e.g. ten words). A location of the portion can be pre-configured by a configurator (138), for example, wherein the portion is located in a first paragraph of an abstract of a candidate document. The portion is preferably associated with at least one matching component (e.g. a portion comprising ten words immediately preceding a matching component).

Preferably, the extractor (135) also extracts further data associated with the portion (e.g. an identifier associated with the candidate document etc.). In the first example, a portion is shown below:
Portion: Doc Id=2; “High cholesterol when seen in the presence of other conditions such as high blood pressure increases the risk of heart attack”.

A display component (139) displays (step 225) the portion (and any further data associated with the portion) to the user. The display component (139) can also display the location of the matching components received from the search engine (120), data received from the analyser (130) etc.

Advantageously, data associated with the portion represents a possible explanation of the rule. Specifically, a correlation is found in data using a data mining technique. Then, the same (or substantially the same) correlation is searched for in a corpus of text. Preferably, further text mining techniques are applied (e.g. proximity analysis). Text provides content and context and thus, if the correlation is found in the text, the text provides context associated with the correlation. This context can then be used to suggest one or more explanations for the correlation.

The document corpus can comprise data associated with several domains (e.g. the Internet, an intranet etc.) or can comprise data associated with a particular domain (e.g. a store associated with specialised documents). Thus, if a correlation in the set of records can be discovered in the document corpus, a portion associated with the document corpus (preferably wherein the portion is associated with the correlation) can be extracted. The portion can be displayed to a user as a possible explanation of the correlation (e.g. a medical cause associated with correlation in patient data), context of the correlation etc.

If a document corpus associated with several domains is used, advantageously, new explanations for a correlation can be found. If a document corpus associated with a particular domain is used, advantageously, explanations that are relevant for a correlation can be found.

In one embodiment a ranker (136) ranks a plurality of candidate documents before the extracting step. For example, the ranker (136) ranks the candidate documents by a number of matching components found within each document; by a location at which a matching component was found (e.g. abstract, main body, glossary etc.) etc. In response to the ranking step being performed before the extracting step, a selector (137) selects a candidate document on which to perform the extracting step.

In another embodiment, the ranker (136) ranks a plurality of extracted portions after the extracting step. For example, the ranker (136) ranks the extracted portions by a number of matching components found within each portion; by a location associated with the portion (e.g. abstract, main body, glossary etc.) etc. In response to the ranking step being performed after the extracting step, the selector (137) selects an extracted portion from the extracted portions for display.

Preferably, at least one technique is applied to a plurality of candidate documents, after extraction, to provide the user with data that is easier to understand.

For example, clustering (which attempts to group data sets according to how similar they are to each other) can be applied to the plurality of candidate documents, wherein each extracted portion is separately labelled with an identifier (e.g. a document identifier) and data associated with each portion is clustered, for example, clustering by keyword, clustering by topic etc. (e.g. using a text based clustering algorithm), resulting in one or more “clusters”, each cluster comprising at least one portion. It should be understood that each “cluster” represents a different potential explanation of the rule. Preferably, each cluster can be summarised to the user.

1. A system for providing context associated with data mining results, for use with a data mining application for mining a first document set and for determining, in response to the mining, a correlation, wherein the system comprises:
a search means for comparing the correlation against content of a second document set to search for a matching correlation, and
an extractor for extracting, in response to finding the matching correlation in a document of the second document set, a set of contextual data associated with the document of the second document set.

2. A system as claimed in claim 1, further comprising a generator for using the correlation to generate a search input.

3. A system as claimed in claim 2, wherein the search means compares the search input to the content of the second document set.

4. A system as claimed in claim 1, wherein the search means generates search results comprising components of the matching correlation.

5. A system as claimed in claim 4, further comprising an analyser for analysing the search results to generate data associated with the matching correlation.

6. A system as claimed in claim 5, wherein the analyser executes a proximity analysis.

7. A system as claimed in claim 1, further comprising a display component for displaying the set of contextual data associated with the document.

8. A system as claimed in claim 1 wherein the set of contextual data associated with the document is associated with the correlation.

9. A system as claimed in claim 1 wherein a size of the set of contextual data associated with the document is pre-configurable.

10. A system as claimed in claim 1 wherein a location of the set of contextual data associated with the document is pre-configurable.

11. A system as claimed in claim 1, further comprising a ranker for ranking, in response to finding the matching correlation in a plurality of documents of the second document set, the plurality of documents.

12. A system as claimed in claim 11, further comprising a selector for selecting at least one of the ranked plurality of documents.

13. A system as claimed in claim 12, wherein the extractor extracts a set of contextual data associated with the selected document.

14. A method for providing a service to a customer for providing context associated with data mining results, for use with a data mining application for mining a first document set and for determining, in response to the mining, a correlation, comprising:
comparing the correlation against a second document set to search for the correlation; and
extracting, in response to finding the correlation in a document of the second document set, a set of contextual data associated with the document.

15. A method as claimed in claim 14, further comprising the step of using the correlation to generate a search input.

16. A method as claimed in claim 15, further comprising the step of comparing the search input to the content of the second document set.

17. A method as claimed in any of claims 15, further comprising the step of generating search results comprising components of the matching correlation.

18. A method as claimed in claim 17, further comprising the step of analysing the search results to generate data associated with the matching correlation.

19. A method as claimed in claim 18, further comprising the step of executing a proximity analysis.

20. A method as claimed in claim 14, further comprising the step of displaying the set of contextual data associated with the document.

21. A method as claimed in claim 14, wherein the set of contextual data associated with the document is associated with the correlation.

22. A method as claimed in claim 14, wherein a size of the set of contextual data associated with the document is pre-configurable.

23. A method as claimed in claim 14, wherein a location of the set of contextual data associated with the document is pre-configurable.

24. A method as claimed in claim 14, further comprising the step of ranking, in response to finding the matching correlation in a plurality of documents of the second document set, the plurality of documents.

25. A method as claimed in claim 24, further comprising the step of selecting at least one of the ranked plurality of documents.

26. A computer-readable storage medium comprising program instructions which when executed by a computer controls the computer to perform the method steps of:
comparing the correlation against content of a second document set to search for a matching correlation, and
extracting, in response to finding the matching correlation in a document of the second document set, a set of contextual data associated with the document of the second document set.

27. The storage medium of claim 26, further comprising program code instructions for using the correlation to generate a search input.

28. The storage medium of claim 27, further comprising program code instructions for comparing the search input to the content of the second document set.

29. The storage medium of claim 26, further comprising program code instructions for generating search results comprising components of the matching correlation.

30. The storage medium of claim 29, further comprising program code instructions for analysing the search results to generate data associated with the matching correlation.

31. The storage medium of claim 26, further comprising program code instructions for executing a proximity analysis.

32. The storage medium of claim 26, further comprising program code instructions for displaying the set of contextual data associated with the document.

33. The storage medium of claim 26, wherein the set of contextual data associated with the document is associated with the correlation.

34. The storage medium of claim 26, wherein a size of the set of contextual data associated with the document is pre-configurable.

35. The storage medium of claim 26, wherein a location of the set of contextual data associated with the document is pre-configurable.

36. The storage medium of claim 26, further comprising program code instructions for ranking, in response to finding the matching correlation in a plurality of documents of the second document set, the plurality of documents.

37. The storage medium of claim 36, further comprising program code instructions for selecting at least one of the ranked plurality of documents.
